(19) United States
(12) Patent Application Publication
(10) Pub. No.: US 2016/0306073 A1
(43) Pub. Date: Oct. 20, 2016

(54) Downhole Sensing Systems and Methods Employing Spectral Analysis of Time-Division Multiplexed Pulse Sequences

(71) Applicant: HALLIBURTON ENERGY SERVICES, INC., Houston, TX (US)

(72) Inventors: Han-Sun CHOI, Houston, TX (US); Etienne M. Samson, Cypress, TX (US)

(73) Assignee: Halliburton Energy Services, Inc., Houston, TX (US)

(21) Appl. No.: 14/401,090

(22) PCT Filed: Jan. 7, 2014
(86) PCT No.: PCT/US2014/010399

§ 371 Date: Nov. 13, 2014

(51) Int. Cl. G01V 8/24; E21B 47/00; E21B 47/12; E21B 47/06

(52) U.S. Cl. CPC G01V 8/24; E21B 47/06; E21B 47/065; E21B 47/00; E21B 47/123; G01J 3/26

(57) ABSTRACT

An illustrative downhole sensing system and method employs an array of downhole sensors such as extrinsic Fabry-Perot interferometers, each of which provides a sequence of light pulses having spectra indicative of a measurand for that downhole sensor. An optical fiber conveys the sequences in a time-multiplexed fashion to a receiver having at least one gating element that passes only a selected one of the sequences and at least one spectrometer that receives the selected one of said sequences and responsively measures a light spectrum. Notably, the integration interval for the spectrometer measurement is substantially greater than the pulse period of each sequence, including multiple pulses within the measurement by the spectrometer.

### BACKGROUND

Optical sensing technology is turning out to be suitable for a number of downhole applications ranging from temperature sensing to passive seismic monitoring. As engineers develop new and improved systems to increase performance and sensitivity, they have encountered certain obstacles. For example, sensor types such as those disclosed in U.S. Pat. No. 7,564,562 (“Method for demodulating signals from a dispersive white light interferometric sensor”) rely on spectral analysis of broadband light for proper operation, which makes it difficult for a single optical fiber to provide multiplexed access to multiple such sensors. (In the context of optical sensing systems relying on signals in the 1460-1675 nm range, broadband may be taken to mean a spectrum having a full-width at half maximum greater than 80 nm.) The conventional multiplexing approach, wavelength division multiplexing (WDM), apportions only relatively small portions of the spectrum to each sensor to avoid expanding the system bandwidth beyond what the typical communications fiber can handle.

Time division multiplexing (TDM) is another multiplexing approach that has been employed in optical sensing systems for signals that do not require spectral analysis. See, e.g., U.S. Pat. No. 7,221,815 (“Optical sensor multiplexing system”). However, commercially available spectrometers generally require a measurement time on the order of 1 ms, and in any event no less than 200 μs. Assuming a typical fiber delay of 5 ns/m, a fiber delay coil employed to provide such a long delay time would be on the order of 100 km long. Such inter-sensor spacings are simply infeasible in a downhole sensing system. The only other proposed solution known to the authors has been the use of one or more dedicated fibers for each sensor requiring spectral analysis. This approach becomes infeasible as the number of downhole sensors increases.

### BRIEF DESCRIPTION OF THE DRAWINGS

Accordingly, there are disclosed in the drawings and the following description certain methods and systems suitable for enabling spectral analysis of time-division multiplexed (TDM) signals from downhole sensors. In the drawings:

FIG. 1 shows an illustrative downhole optical sensor system in a production well.

FIG. 2 shows an alternative downhole optical sensor system embodiment.

FIG. 3 is a schematic diagram of an illustrative downhole sensing system that provides spectral analysis of TDM signals.

FIGS. 4a-4b show two illustrative methods for generating a sequence of broadband light pulses.

FIG. 5 is an illustrative timing diagram.

FIG. 6 is a flowchart of an illustrative downhole sensing method that provides spectral analysis of TDM signals.

FIG. 7 shows an illustrative log of a distributed downhole parameter.

It should be understood, however, that the specific embodiments given in the drawings and detailed description thereto do not limit the disclosure. On the contrary, they provide the foundation for one of ordinary skill to discern the alternative forms, equivalents, and modifications that are encompassed together with one or more of the given embodiments in the scope of the appended claims.

### DETAILED DESCRIPTION

The obstacles outlined above are at least in part addressed by the disclosed downhole sensing systems and methods. Some disclosed system embodiments include an array of downhole sensors, each of which provides a sequence of light pulses having spectra indicative of a measurand for that downhole sensor. An optical fiber conveys the sequences in a time-multiplexed fashion to a receiver having at least one gating element that passes only a selected one of the sequences and at least one spectrometer that receives the selected one of said sequences and responsively measures a light spectrum. Notably, the integration interval for the spectrometer measurement is substantially greater than the pulse period of each sequence, including multiple pulses within the measurement by the spectrometer.

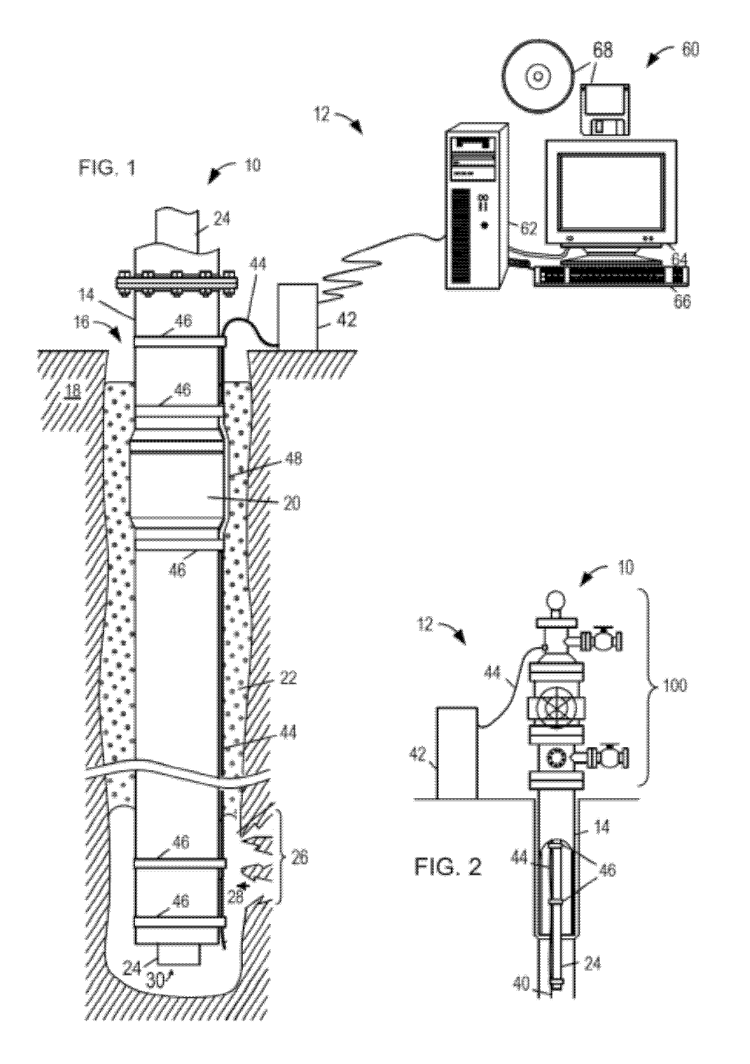

Turning now to the figures, FIG. 1 shows a well 10 equipped with an illustrative embodiment of a downhole optical sensor system 12. A drilling rig has been used to drill and complete the well 10 in a typical manner, including the assembly and installation of a casing string 14 in the borehole 16 penetrating the earth 18. The casing string 14 is assembled from multiple tubular casing sections (usually about 30 foot long) connected end-to-end by couplings 20 as the casing string is gradually lowered into the borehole. (FIG. 1 is not to scale. Typically the casing string includes many such couplings.) After each casing section is attached to the casing string 14, a fiber optic cable 44 is strapped to the casing section and it is lowered far enough for another casing section to be attached. Once the casing string is fully positioned within the well 10, a cement slurry 22 is been injected into the annular space between the outer surface of the casing string 14 and the inner surface of the borehole 16 and allowed to set. A production tubing string 24 can then be assembled and positioned in a similar fashion inside the inner bore of the casing string 14.

The well 10 is adapted to guide a desired fluid (e.g., oil or gas) from a bottom of the borehole 16 to a surface of the earth 18. Perforations 26 have been formed at a bottom of the borehole 16 to facilitate the flow of a fluid 28 from a surrounding formation into the borehole and thence to the surface via an opening 30 at the bottom of the production tubing string 24. Note that this well configuration is illustrative and not limiting on the scope of the disclosure.

The downhole optical sensor system 12 includes an interface 42 coupled to the fiber optic cable 44 for communication with an array of downhole sensors as discussed further below. The interface 42 is located on the surface of the earth 18 near the wellhead, i.e., a “surface interface”. In the embodiment of FIG. 1, the fiber optic cable 44 extends along an outer surface of the casing string 14 and is held against the outer surface of the of the casing string 14 at spaced apart locations by multiple bands 46 that extend around the casing string 14. A protective covering may be installed over the fiber optic cable 44 at each of the couplings 20 of the casing string 14 to prevent the cable 44 from being pinched or sheared by the coupling's contact with the borehole wall. In FIG. 1, a protective covering 48 is installed over the fiber optic cable 44 at the coupling 20 of the casing string 14 and is held in place by two of the bands 46 installed on either side of coupling 20.

In at least some embodiments, the fiber optic cable 44 terminates at surface interface 42 with an optical port adapted for coupling the fiber(s) in cable 44 to a light source and a detector. The light source transmits a sequence of broadband light pulses along the fiber optic cable 44 to the spaced-apart downhole sensors, each of which returns a modified sequence of light pulses have a spectrum indicative of a measurand. In at least some embodiments, the sensors are extrinsic Fabry-Perot interferometers (EFPI), such as those described in U.S. Pat. No. 5,301,001 (“Extrinsic fiber optic displacement sensors and displacement sensing systems”), U.S. Pat. No. 7,564,562 (“Method for demodulating signals from a dispersive white light interferometer sensor”), and Choi, Cantrelle, Bergeron, and Tubel, “Minimization of temperature cross-sensitivity of EFPI pressure sensor for oil and gas exploration and production applications in well bores”, SPIE Vol. 5589 p. 337-344, Optics East 2004, Philadelphia.

The EFPI sensors provide a gap (such as an air gap) that can be configured to respond to temperature, pressure, stress, acceleration, and other measurands. The relevant literature provides a number of low-cost EFPI sensor designs having linear parameter dependencies with negligible cross-sensitivities to other parameters and no polarization sensitivity, which can be used to provide a low-cost, high performance remote sensing system, once the multiplexing obstacles have been overcome as set out below. The optical port communicates the modified pulse sequences to the detector. As will be explained in greater detail below, the detector measures the spectra of the modified pulse sequences.

The illustrative downhole optical sensor system 12 of FIG. 1 further includes a computer 60 coupled to the surface interface 42 to control the light source and detector. The illustrated computer 60 includes a chassis 62, an output device 64 (e.g., a monitor as shown in FIG. 1, or a printer), an input device 66 (e.g., a keyboard), and non-transient information storage media 68 (e.g., magnetic or optical data storage disks). However, the computer may be implemented in different forms including, e.g., an embedded computer permanently installed as part of the surface interface 42, a tablet or portable computer that is plugged into or wirelessly linked to the surface interface 42 as desired to collect data, and a remote desktop computer coupled to the surface interface 42 via a wireless link and/or a wired computer network. The computer 60 is adapted to receive the spectra measurement signals produced by the surface interface 42 and to responsively derive and track measurand values at each sensor position.

In at least some implementations, the non-transient information storage media 68 stores a software program for execution by computer 60. The instructions of the software program cause the computer 60 to collect spectra measurements received as a digital signal from surface interface 42 and, based at least in part thereon, to determine downhole parameters such as temperatures at each sensor position on the fiber 44. The instructions of the software program may also cause the computer 60 to display the parameter values associated with each sensor position via the output device 64.

FIG. 2 shows an alternative embodiment of downhole optical sensor system 12 having the fiber optic cable 44 strapped to the outside of the production tubing 24 rather than the outside of casing 14. Rather than exiting the well 10 from the annular space outside the casing, the fiber optic cable 44 exits through an appropriate port in the “Christmas tree” 100, i.e., the assembly of pipes, valves, spools, and fittings connected to the top of the well to direct and control the flow of fluids to and from the well. The fiber optic cable 44 extends along the outer surface of the production tubing string 24 and is held against the outer surface of the of the production tubing string 24 at spaced apart locations by multiple bands 46 that extend around the production tubing string 24. The downhole optical sensor system 12 of FIG. 2 optionally includes a hanging tail 40 at the bottom of a borehole. In other system embodiments, the fiber optic cable 44 may be suspended inside the production tubing 24 and held in place by a suspended weight on the end of the fiber.

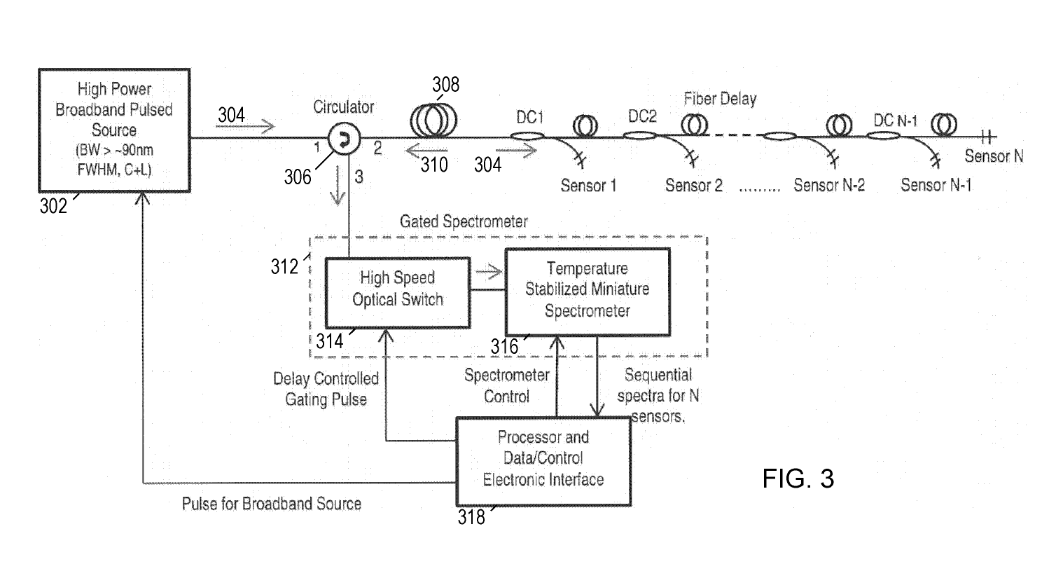

FIG. 3 shows the illustrative downhole sensing system in schematic form. A high power broadband pulsed source 302 generates a sequence of broadband light pulses 304 which is directed downhole by an optical circulator 306. The delays encountered as sequence 304 propagates along cable 44 are represented in FIG. 3 as delay coils 308, though in practice no such coils would be employed. A series of couplers DC1, DC2, . . . DC(N−1) each direct a portion of the downgoing sequence 304 to a corresponding sensor S1, S2, . . . , S(N−1), while passing along the rest of the downgoing light energy. A final sensor SN may be positioned downhole of the last coupler DC(N−1). Various coupler designs may be employed, including beam splitters and fiber-to-fiber evanescent-wave or near-field couplers. For a balanced distribution of the downgoing light energy among the sensors, each subsequent coupler should divert an increasing fraction of the light, e.g., 1/N, 1/(N−1), . . . , ½. The actual fractions may vary as various forms of loss are taken into account.

As mentioned previously, each sensor may be an EFPI sensor having a gap in the fiber that introduces two index of refraction mismatches; one on each side of the gap. The light passing into the gap is partially transmitted and partially reflected, as is the light passing out of the gap on the other side. Any light in the cavity can be reflected back and forth multiple times inside the cavity before escaping. The constructive and destructive interference in the light leaving both sides of the gap produces a distinctive spectral pattern that reveals the width of the gap in the fiber, which gap may be designed to be sensitive to a selected measurand, e.g., temperature, pressure, stress, acceleration, etc. The reflected light from each sensor is a sequence of pulses having a modified spectrum, and the couplers DC1-DC(N−1) return the modified pulse sequences to the fiber as upgoing sequences 310. Alternatively, an upgoing signal fiber separate from the downgoing signal fiber can be employed to collect the modified pulse sequences (in the form of light that has transmitted through the EFPI sensor) with a second set of couplers and transport it to the surface. In either case, the signal propagation delay associated with the inter-sensor spacing causes each downgoing pulse to produce a series of upgoing pulses, each upgoing pulse having a unique delay as determined by the position of the couplers along the cable 44.

Circulator 306 directs the upgoing sequences to a detector 312 having a spectrometer 316. At the input to the spectrometer 316, a high-speed optical switch 314 gates the upgoing pulse sequences, enabling the spectrometer to receive only a selected one of the pulse sequences corresponding to a currently selected sensor. A processing unit 318 coordinates the operation of the source 302 and the receiver 312, adjusting the timing of switch 314 relative to the firing of source 302 to control which sensor-modified pulse sequence the spectrometer 316 is measuring. Processing unit 318 further initiates spectrometer measurements and receives the resulting spectra.

In at least some embodiments, the processing unit 318 performs the selection operation by generating clock signals for the source 302 and the switch 314, using an adjustable delay based on the spacing of the sensors to select any given one of the sensors. The pulse period, pulse width, and adjustable delay settings are expected to be set by the operator during system initialization, based on the given configuration of downhole sensors. Alternatively, these settings may be determined iteratively or adaptively, enabling the processing unit 318 to discover the optimal timing for array interrogation and sensor selections.

The high-speed optical switch may take the form of a High Speed Variable Attenuator available from Boston Applied Technologies. The spectrometer 316 may take the form of a miniature spectrometer from Ocean Optics of Dunedin, Fla.

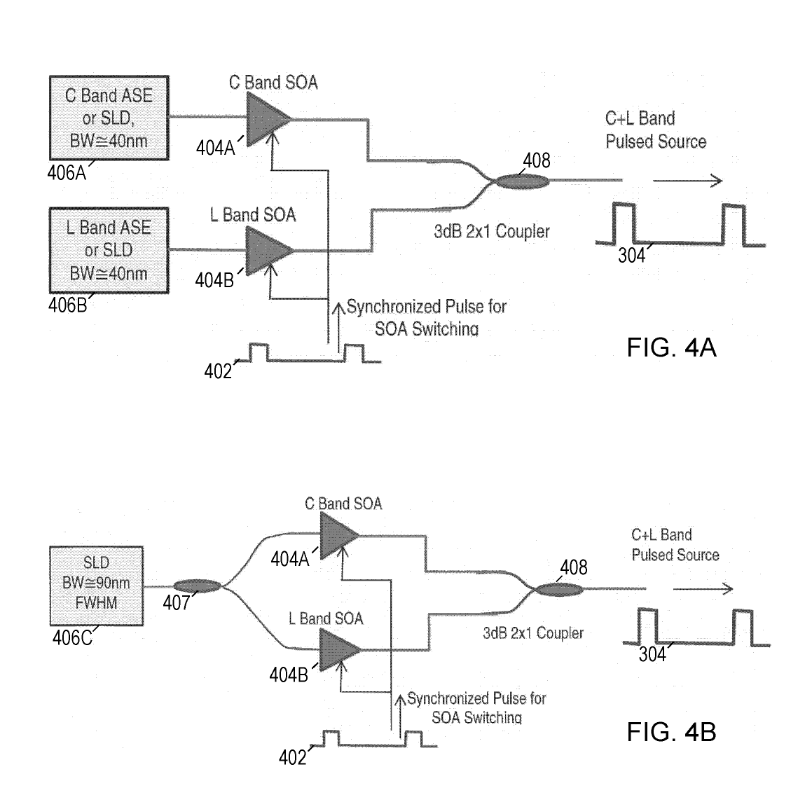

FIGS. 4A-4B show two illustrative methods for generating a sequence of broadband light pulses. FIG. 4A shows a clock signal 402 from processing unit 318 being directed to two stimulated optical amplifiers (SOA) 404A, and 404B. When the clock signal is asserted, SOA 404A amplifies in the C-band (˜1530-1565 nm) while SOA 404B amplifies in the L-band (˜1565-1625 nm). During these assertions, light from C-band source 406A is amplified by SOA 404A to produce a C-band light pulse, and light from L-band source 406B is amplified by SOA 404B to produce an L-band light pulse. A 2×1 coupler 408 combines the pulses to produce the sequences of broadband light pulses 304. FIG. 4B shows an alternative embodiment in which the separate sources 406A, 406B are replaced by a single source 406C having a broader bandwidth and a splitter 407 that distributes the light to both SOAs 404A, 404B. The light sources may be super luminescent diodes (SLD), amplified spontaneous emitters (ASE), or other commercially available sources. U.S. Pat. App. Pub. 2011/0032605 “Pulsed Optical Source” by Kliner et al. discloses additional implementation details of one suitable source.

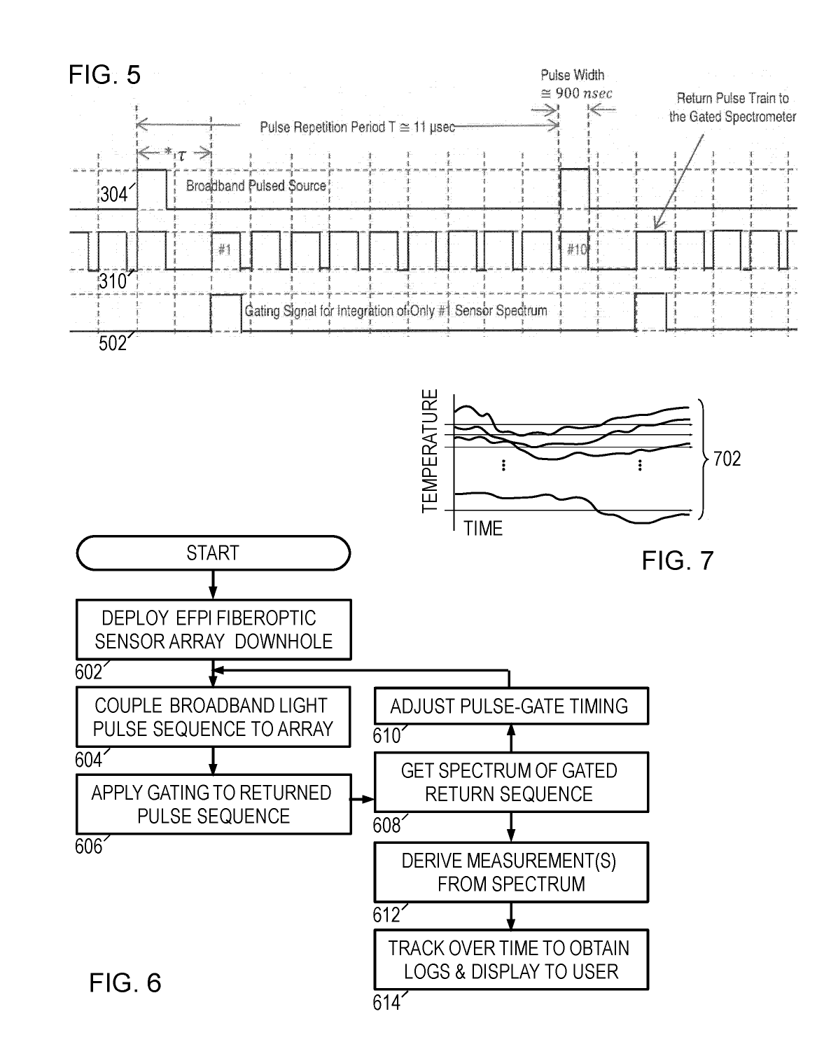

To further explain the time-division multiplexing aspects of the system, FIG. 5 shows an illustrative timing diagram, in which the broadband pulse sequence 304 includes pulses having a pulse width of ˜900 ns and a pulse period of 11 μs. The upgoing pulse sequence signal 310 is responsively produced by 10 downhole sensors. The 10 sensors are spaced approximately 100 m apart, so the signal 310 has 10 responsive pulses for every transmitted pulse from the source. Due to the 200 m separation between the source and the first sensor in the present example, there is a 2 μs delay between the initiation of the source pulse and the beginning of the response pulse from the first sensor. (Though an illustrative value has been provided here, the distance from the source to the first sensor is largely irrelevant except for the attenuation incurred by light traversing that interval.) Thereafter there is a 1 μs delay to the beginning of each subsequent pulse until the tenth pulse is received. In other words, taking the beginning of the source pulse as the beginning of a pulse period, the modified pulse from the first sensor is received in the time window between 2-3 μs, the modified pulse from the second sensor is received in the time window between 3-4 μs, the modified pulse from the third sensor between 4-5 μs, and so on.

To separate out only the pulses from a given sensor, the processing unit 318 supplies a clock signal 502 to switch 314, causing the switch to pass only the pulses in the time window corresponding to the selected sensor. (In the figure, sensor #1 is selected.) Such gating is desirable because, depending on the model, the typical minimum integration time for a commercially available miniature spectrometer ranges from 200 μs to 1 ms. This integration time is far larger than the maximum pulse width that can be used without overlapping responses from the downhole sensor array. The switch 314 blocks all but the pulses from the selected sensor, enabling the spectrometer to analyze the pulses from the selected sensor without interference, using an integration time that can be extended over as many pulses as needed to achieve the desired signal-to-noise ratio.

FIG. 6 is a flowchart of an illustrative downhole sensing method. It begins in block 602 with the deployment of an array of EFPI fiberoptic sensors in a downhole environment. For example, a completions crew may strap the array to the casing or production tubing, or a wireline crew may deploy the array inside the tubing or open borehole using a weighted end. In block 604, a logging crew couples the array to a source of broadband light pulses, e.g., via a surface interface 42. As the source generates a sequence of downgoing pulses, each sensor provides a responsive sequence of return pulses. The pulse period and pulse width are chosen so that the upgoing pulse sequences interleave in a time-multiplexed manner.

In block 606, the receiver gates the received signal to pass only the upgoing pulses from one selected sensor. In block 608, the spectrometer measures the spectrum of the pulses from the selected sensor, e.g., by using a diffractive or refractive element to disperse the spectral components across a charge-coupled device (CCD) or other array of photodetectors. Once enough pulses have been collected to complete the spectrum measurement, the receiver adjusts the timing of the gate pulses relative to the source pulses in block 610, so as to select the pulses from another sensor. Blocks 604-610 are repeated to collect measurements from each sensor in turn, and then further repeated to collect subsequent measurements from each sensor.

If M pulse periods (M>1) are needed for an adequate spectrum measurement, the full measurement cycle using one spectrometer is approximately MN pulse periods, where N is the number of sensors. Moreover, since each pulse period is a minimum of N pulse widths, the full measurement cycle is at least MN² pulse widths. To keep the measurement cycle from becoming prohibitively long, the number of sensors N for a given fiber may be limited. Additional fibers (and spectrometers) may be added to the system to support additional sensors. For example, one fiber having 10 sensors for pressure measurements may be paired with a second fiber having 10 sensors for temperature measurements. Illustrative values include M=1000, N=10, and a pulse width of 1 μs, yielding a single-spectrometer measurement cycle of 0.1 s, for a sensor logging rate of 10 Hz, which is more than enough for pressure and temperature profile monitoring.

In block 612, the receiver converts the spectrum measurement into a sensor measurand, e.g., pressure, temperature, strain, etc. In block 614, the measurand values are tracked as a function of time to obtain a log of the desired parameters for display to a user. One illustrative log display is given in FIG. 7 as a “waterfall plot”. A graph 702 of the measured temperature versus time is shown for each sensor, with the graphs being spatially offset in a manner that corresponds to the relative spatial positions of the sensors. Typically such displays enable a user to readily see the correlations between sensor measurements to facilitate the user's understanding of the relevant information, e.g., the motion of fluids in the borehole and/or surrounding formation.

Numerous variations and modifications will become apparent to those skilled in the art once the above disclosure is fully appreciated. For example, the figures show system configurations suitable for production monitoring, but they are also readily usable for monitoring treatment operations, cementing operations, and field activity monitoring. It is intended that the following claims be interpreted to embrace all such variations and modifications.

What is claimed is:

1. A downhole sensing system that comprises:
an array of downhole sensors, each of which provides a sequence of light pulses having spectra indicative of a measurand for that downhole sensor, each of said sequences further having a pulse period;
an optical fiber that conveys said sequences in a time-multiplexed fashion;
a receiver coupled to the optical fiber to receive said sequences, wherein the receiver includes:
at least one gating element that passes only a selected one of said sequences; and
at least one spectrometer that receives the selected one of said sequences and responsively measures a light spectrum no more than once per integration interval, wherein the integration interval is no less than twice the pulse period.

2. The system of claim 1, further comprising a processing unit that selects a different one of said sequences after each spectrum measurement by the at least one spectrometer.

3. The system of claim 2, wherein the processing unit processes the measured light spectra to derive and track a measurand value for each of the downhole sensors.

4. The system of claim 1, further comprising a source of pulsed light having a spectral bandwidth greater than 80 nm, wherein said optical fiber conveys a sequence of pulses from the source to the array of downhole sensors.

5. The system of claim 1, wherein the receiver comprises multiple spectrometers, each measuring a light spectrum of a different one of said sequences.

6. The system of claim 1, wherein the pulse period includes a pulse width that is limited by a round trip travel time between adjacent downhole sensors, and wherein the pulse period further includes a pulse spacing that is limited by a round trip travel time between first and last downhole sensors in the array.

7. The system of claim 1, wherein the measurands are each in a set consisting of temperature, pressure, and strain.

8. The system of claim 1, wherein each downhole sensor is an extrinsic Fabry-Perot interferometer.

9. A downhole sensing method that comprises:
conveying a sequence of broadband light pulses to an array of downhole sensors, said sequence having a pulse period and each downhole sensor responsively generating a modified sequence of light pulses having a spectrum indicative of a measurand for that downhole sensor;
receiving, via an optical fiber, said modified sequences in a time multiplexed fashion; and
measuring a spectrum of a selected one of the modified sequences with a spectrometer having an integration time no less than twice the pulse period.

10. The method of claim 9, further comprising:
deriving a measurand value from the spectrum; and
displaying a visual representation of the measurand value.

11. The method of claim 9, wherein said measuring includes gating a signal from the optical fiber to block all but the selected one of the modified sequences.

12. The method of claim 11, further comprising repeating said measuring with different selected ones of the modified sequences to obtain a spectrum for each modified sequence.

13. The method of claim 12, further comprising deriving and tracking measurand values for each downhole sensor based on said spectra.

14. The method of claim 9, wherein the broadband light pulses have a bandwidth in excess of 80 nm.

15. The method of claim 9, further comprising using one or more additional spectrometers to concurrently measure spectra of different ones of the modified sequences, each spectrometer having the same integration time.

16. The method of claim 9, wherein the pulse period includes a pulse width that is limited by a round trip travel time between adjacent downhole sensors, and wherein the pulse period further includes a pulse spacing that is limited by a round trip travel time between first and last downhole sensors in the array.

17. The method of claim 9, wherein the measurands are each in a set consisting of temperature, pressure, and strain.

18. The method of claim 9, wherein each downhole sensor is an extrinsic Fabry-Perot interferometer.
